(19) United States
(12) Patent Application Publication
(10) Pub. No.: US 2026/0162265 A1
(43) Pub. Date: Jun. 11, 2026

(54) METHOD, APPARATUS, AND MEDICAL IMAGING SYSTEM FOR SETTING A SCANNING REGION IN A MEDICAL IMAGING SYSTEM

(71) Applicant: GE Precision Healthcare LLC, Waukesha, WI (US)

(72) Inventors: Chu Wang, Beijing (CN); Yaan Ge, Beijing (CN); Xiaolon Liu, Beijing (CN); Kun Wang, Beijing (CN)

(21) Appl. No.: 19/409,408

(22) Filed: Dec. 4, 2025

(30) Foreign Application Priority Data
Dec. 5, 2024 (CN) 202411785757.6

(51) Int. Cl. G06T 7/00; G06T 12/10

(52) U.S. Cl. CPC G06T 7/0014; G06T 12/10; G06T 2207/10088

(57) ABSTRACT

A scanning region setting method for a medical imaging system is provided. The method includes: setting a first scanning region in a reference medical image, the reference medical image being a composite image generated by stitching a first medical scan image and a second medical scan image, or the reference medical image including any one of the first medical scan image and the second medical scan image, where the first scanning region is located on at least one of the first medical scan image and the second medical scan image. In the present application, one or more second scanning regions are automatically set according to a first scanning region, such that the workload in a process of setting a scanning region can be reduced, and the time required to set the scanning region can be shortened, thereby improving scanning efficiency

### CROSS REFERENCE TO RELATED APPLICATIONS

The present application claims priority and benefit of Chinese Patent Application No. 202411785757.6 filed on Dec. 5, 2024, which is incorporated herein by reference in its entirety.

### TECHNICAL FIELD

Embodiments of the present application relate to the technical field of medical devices, and in particular to a scanning region setting method and apparatus for a medical imaging system, and a medical imaging system.

### BACKGROUND

In a scenario in which a medical imaging apparatus is used to scan and image a subject under examination, sometimes a range that needs to be scanned is greater than a scan field of view (FOV) of the medical imaging apparatus, and thus a plurality of scanning regions need to be set. By scanning the plurality of scanning regions, a plurality of medical scan images are obtained, and these medical scan images can be merged to cover the range that needs to be scanned in the subject under examination.

When different scanning regions are scanned, the relative positions of the subject under examination and a medical imaging system change, and thus a corresponding scanning region of the subject under examination can enter a scan field of view of the medical imaging system.

Scanning a plurality of scanning regions by using a medical imaging system may also be referred to as multi-station scanning.

It should be noted that the above introduction of the background is only for the convenience of clearly and completely describing the technical solutions of the present application, and for the convenience of understanding for those skilled in the art.

### SUMMARY

Before scanning a subject under examination, a medical imaging system is generally used to perform a preliminary scan on the subject under examination to obtain one or more 3-plane localizer images of the subject under examination, wherein the three planes comprise, for example, a sagittal plane, a coronal plane, and a horizontal plane. For example, the 3-plane localizer image may comprise a first medical scan image obtained by scanning the upper portion of the subject under examination and a second medical scan image obtained by scanning the lower portion of the subject under examination.

In the prior art, an operator (for example, a physician) of a medical imaging system can set a first scanning region in the first medical scan image, and then set a second scanning region in the second medical scan image. Therefore, the medical imaging system can scan the subject under examination according to the set first scanning region and the set second scanning region, respectively, thereby implementing multi-region scanning (for example, multi-region scanning refers to scanning of two regions, i.e., the first scanning region and the second scanning region).

The inventor of the present application has found that in the prior art, the operator needs to manually set a plurality of scanning regions, wherein in a process of setting the plurality of scanning regions, it is necessary to ensure that adjacent scanning regions are aligned, and that adjacent scanning regions have an overlap of a predetermined size in a specified direction so as to ensure that a range that needs to be scanned is completely covered, and this process of manually setting the scanning regions will increase the operator's workload and prolong operation time.

In order to solve the above technical problems or at least similar technical problems, embodiments of the present application provide a scanning region setting method and apparatus for a medical imaging system, and a medical imaging system. In the method, one or more second scanning regions are automatically set according to a first scanning region, such that the workload in a process of setting a scanning region can be reduced, and the time required to set the scanning region can be shortened, thereby improving scanning efficiency.

According to one aspect of the embodiments of the present application, a scanning region setting method for a medical imaging system is provided for setting a scanning region in medical imaging. The method comprises:
setting a first scanning region in a reference medical image, the reference medical image being a composite image generated by stitching a first medical scan image and a second medical scan image, or the reference medical image comprising any one of the first medical scan image and the second medical scan image, wherein the first scanning region is located on at least one of the first medical scan image and the second medical scan image; and
setting one or more second scanning regions according to the first scanning region.

According to one aspect of the embodiments of the present application, a medical imaging system is provided. The system comprises: a controller configured to execute the foregoing scanning region setting method.

One of the beneficial effects of the embodiments of the present application is that: one or more second scanning regions are automatically set according to a first scanning region, such that the workload in a process of setting a scanning region can be reduced, and the time required to set the scanning region can be shortened, thereby improving scanning efficiency.

With reference to the following description and drawings, specific implementations of the embodiments of the present application are disclosed in detail, and the way in which the principles of the embodiments of the present application can be employed are illustrated. It should be understood that the implementations of the present application are not limited in scope thereby. Within the scope of the spirit and clauses of the appended claims, the implementations of the present application comprise many changes, modifications, and equivalents.

### BRIEF DESCRIPTION OF THE DRAWINGS

The included drawings are used to provide further understanding of the embodiments of the present application, which constitute a part of the description and are used to illustrate the implementations of the present application and explain the principles of the present application together with textual description. Evidently, the drawings in the following description are merely some embodiments of the present application, and those of ordinary skill in the art may obtain other implementations according to the drawings without involving inventive effort. In the drawings:

FIG. 1 is a schematic diagram of a magnetic resonance imaging system according to an embodiment of the present application;

FIG. 2 is a schematic diagram of a scanning region setting method in an embodiment of the present application;

FIG. 3 is a schematic diagram of a reference medical image;

FIG. 4 is a schematic diagram of a first scanning region;

FIG. 5 is another schematic diagram of a first scanning region;

FIG. 6 is a schematic diagram of a method for setting one second scanning region according to a first scanning region;

FIG. 7 is a schematic diagram of a first scanning region 301 in a first coordinate system;

FIG. 8 is a schematic diagram of the center C1 of a first scanning region 301 and the center C2 of a second scanning region 302;

FIG. 9 is a schematic diagram of a method for setting two or more second scanning regions according to a first scanning region;

FIG. 10 is a schematic diagram of a scanning region setting apparatus according to an embodiment of the present application;

FIG. 11 is a schematic diagram of a medical imaging system according to an embodiment of the present application; and

FIG. 12 is a schematic diagram of a scanning procedure performed by a magnetic resonance imaging system 100.

### DETAILED DESCRIPTION

The aforementioned and other features of the embodiments of the present application will become apparent from the following description with reference to the drawings. In the description and drawings, specific implementations of the present application are disclosed in detail, and part of the implementations in which the principles of the embodiments of the present application may be employed are indicated. It should be understood that the present application is not limited to the described implementations. On the contrary, the embodiments of the present application include all modifications, variations, and equivalents which fall within the scope of the appended claims.

In the embodiments of the present application, the terms “first” and “second” etc., are used to distinguish different elements, but do not represent a spatial arrangement or temporal order, etc., of these elements, and these elements should not be limited by these terms. The term “and/or” includes any and all combinations of one or more associated listed terms. The terms “comprise”, “include”, “have”, etc., refer to the presence of described features, elements, components, or assemblies, but do not exclude the presence or addition of one or more other features, elements, components, or assemblies.

In the embodiments of the present application, the singular forms “a” and “the”, etc., include plural forms, and should be broadly construed as “a type of” or “a class of” rather than being limited to the meaning of “one”. Furthermore, the term “the” should be construed as including both the singular and plural forms, unless otherwise specified in the context. In addition, the term “according to” should be construed as “at least in part according to . . . ” and the term “on the basis of” should be construed as “at least in part on the basis of . . . ”, unless otherwise specified in the context.

In the embodiments of the present application, the term “key point” may be equivalently replaced with “key coordinate point”, “landmark”, “landmark point”, or the like. The term “subject” may be equivalently replaced with “subject under examination”, “subject being examined”, “subject being scanned”, “subject to be scanned”, “patient”, “subject of study”, or the like, which may be a human being or an animal, or may be other objects.

In the embodiments of the present application, the term “include/comprise” when used herein refers to the presence of features, integrated components, steps, or assemblies, but does not preclude the presence or addition of one or more other features, integrated components, steps, or assemblies.

The features described and/or illustrated for one implementation may be used in one or more other implementations in the same or similar way, be combined with features in other implementations, or replace features in other implementations.

In the embodiments of the present application, a method or apparatus for setting a scanning region may be applicable to various medical imaging scenarios, including, but not limited to, magnetic resonance imaging (MRI), computed tomography (CT), ultrasound imaging, positron emission computed tomography (PET), single photon emission computed tomography (SPECT), PET/CT, PET/MR, or any other suitable medical imaging scenario.

In the embodiments of the present application, an MRI scenario is used as an example to provide an illustrative description of the method, apparatus, and system of the present application, that is, the medical imaging system is exemplified by a magnetic resonance imaging (MRI) system. It may be understood that the disclosure of the embodiments of the present application is also applicable to other medical imaging scenarios.

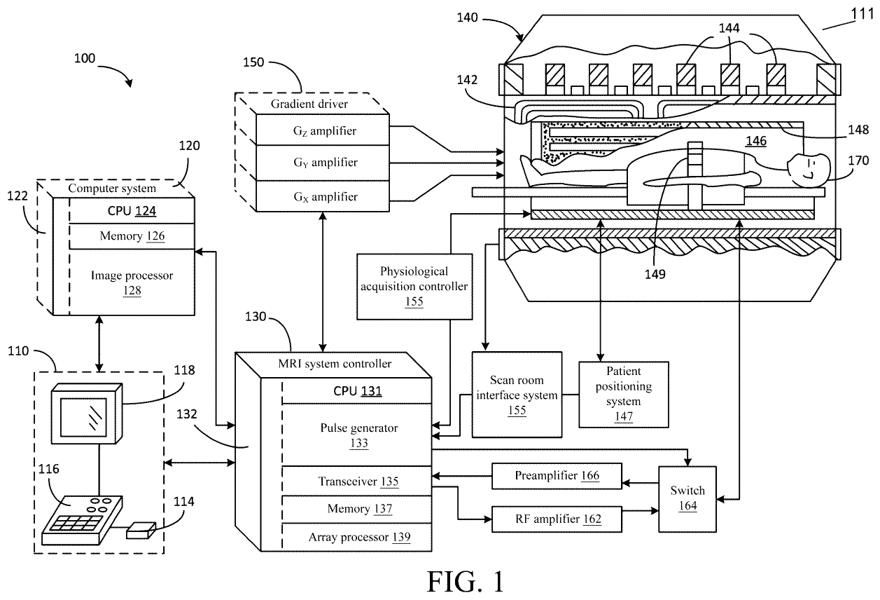

For ease of understanding, FIG. 1 is a schematic diagram of a magnetic resonance imaging (MRI) system 100 according to an embodiment of the present application.

The MRI system 100 includes a scanning unit 111. The scanning unit 111 is used to perform a magnetic resonance scan of a subject (e.g., a human body) 170 to generate image data of a region of interest of the subject 170, where the region of interest may be a pre-determined anatomical site or anatomical tissue.

The operation of the MRI system 100 is controlled by an operator workstation 110 that includes an input device 114, a control panel 116, and a display 118. The input device 114 may be a joystick, a keyboard, a mouse, a trackball, a touch-activated screen, voice control, or any similar or equivalent input device. The control panel 116 may include a keyboard, a touch-activated screen, voice control, a button, a slider, or any similar or equivalent control device. The operator workstation 110 is coupled to and in communication with a computer system 120 that enables an operator to control the generation and display of images on the display 118. The computer system 120 includes various components that communicate with one another by means of an electrical and/or data connection module 122. The connection module 122 may employ a direct wired connection, a fiber optic connection, a wireless communication link, etc. The computer system 120 may include a central processing unit (CPU) 124, a memory 126, and an image processor 128. In some embodiments, the image processor 128 may be replaced by medical imaging functions implemented in the CPU 124. The computer system 120 may be connected to an archive media device, a persistent or backup memory, or a network. The computer system 120 may be coupled to and communicates with a separate MRI system controller 130.

The MRI system controller 130 includes a set of components that communicate with one another via an electrical and/or data connection module 132. The connection module 132 may employ a direct wired connection, a fiber optic connection, a wireless communication link, etc. The MRI system controller 130 may include a CPU 131, a sequence pulse generator (also known as a pulse generator) 133 in communication with the operator workstation 110, a transceiver (also known as an RF transceiver) 135, a memory 137, and an array processor 139.

In some embodiments, the sequence pulse generator 133 may be integrated into a resonance assembly 140 of the scanning unit 111 of the MRI system 100. The MRI system controller 130 may receive a command from the operator workstation 110, and is coupled to the scanning unit 111 to indicate an MRI scanning sequence to be executed during an MRI scan, so as to be used to control the scanning unit 111 to perform the flow of the aforementioned magnetic resonance scan. The MRI system controller 130 is further coupled to a gradient driver system (also known as gradient driver) 150 and is in communication therewith, and the gradient driver system is coupled to a gradient coil assembly 142 to generate a magnetic field gradient during the MRI scan.

The sequence pulse generator 133 may further receive data from a physiological acquisition controller 155 that receives signals from a plurality of different sensors (e.g., electrocardiogram (ECG) signals from electrodes attached to a patient, etc.), the sensors being connected to a subject or patient 170 undergoing the MRI scan. The sequence pulse generator 133 is coupled to and in communication with a scan room interface system 145 that receives signals from various sensors associated with the state of the resonance assembly 140. The scan room interface system 145 is further coupled to and in communication with a patient positioning system 147 that sends and receives signals to control movement of a patient table to a desired position to perform the MRI scan.

The MRI system controller 130 provides gradient waveforms to the gradient driver system 150, and the gradient driver system includes Gₓ (x direction), G_{y} (y direction), and G_{z} (z direction) amplifiers, etc. Each of the Gₓ, G_{y}, and G_{z} gradient amplifiers excites a corresponding gradient coil in the gradient coil assembly 142, so as to generate a magnetic field gradient used to spatially encode an MR signal during an MRI scan. The gradient coil assembly 142 is disposed within the resonance assembly 140, and the resonance assembly further includes a superconducting magnet having a superconducting coil 144 that, in operation, provides a static uniform longitudinal magnetic field B₀ throughout a cylindrical imaging volume 146. The resonance assembly 140 further includes an RF body coil 148, which, in operation, provides a transverse magnetic field B₁, the transverse magnetic field B₁ being substantially perpendicular to B₀ throughout the entire cylindrical imaging volume 146. The resonance assembly 140 may further include an RF surface coil 149 for imaging different anatomical structures of the patient undergoing the MRI scan. The RF body coil 148 and the RF surface coil 149 may be configured to operate in a transmit and receive mode, a transmit mode, or a receive mode.

The x direction may also be referred to as a frequency encoding direction or a kₓ direction in the k-space, the y direction may be referred to as a phase encoding direction or a k_{y} direction in the k-space, and the z direction may be referred to as a layer surface selection (layer selection) direction. Gₓ can be used for frequency encoding or signal readout, and is generally referred to as a frequency encoding gradient or a readout gradient. G_{y} can be used for phase encoding, and is generally referred to as a phase encoding gradient. G_{z} can be used for slice (layer) position selection to obtain k-space data. It should be noted that a layer selection direction, a phase encoding direction, and a frequency encoding direction may be modified according to actual requirements.

The subject or patient 170 of the MRI scan may be positioned within the cylindrical imaging volume 146 of the resonance assembly 140. The transceiver 135 in the MRI system controller 130 generates RF excitation pulses amplified by an RF amplifier 162, and provides the same to the RF body coil 148 through a transmit/receive switch (also known as T/R switch or switch) 164.

As described above, the RF body coil 148 and the RF surface coil 149 may be used to transmit RF excitation pulses and/or receive resulting MR signals from the patient undergoing the MRI scan. The MR signals emitted by excited nuclei in the patient of the MRI scan may be sensed and received by the RF body coil 148 or the RF surface coil 149 and sent back to a preamplifier 166 through the T/R switch 164. The T/R switch 164 may be controlled by a signal from the sequence pulse generator 133 to electrically connect the RF amplifier 162 to the RF body coil 148 in the transmit mode and to connect the preamplifier 166 to the RF body coil 148 in the receive mode. The T/R switch 164 may further enable the RF surface coil 149 to be used in the transmit mode or the receive mode.

In some embodiments, the MR signals sensed and received by the RF body coil 148 or the RF surface coil 149 and amplified by the preamplifier 166 are stored in the memory 137 for post-processing as a raw k-space data array. A reconstructed magnetic resonance image may be obtained by transforming/processing the stored raw k-space data.

In some embodiments, the MR signals sensed and received by the RF body coil 148 or the RF surface coil 149 and amplified by the preamplifier 166 are demodulated, filtered, and digitized in a receiving portion of the transceiver 135, and transmitted to the memory 137 in the MRI system controller 130. For each image to be reconstructed, the data is rearranged into separate k-space data arrays, each of these separate k-space data arrays is inputted into the array processor 139, and the array processor is operated to transform the data into an array of image data by Fourier transform.

The array processor 139 uses transform methods, most commonly Fourier transform, to create images from the received MR signals. These images are transmitted to the computer system 120 and stored in the memory 126. In response to commands received from the operator workstation 110, the image data may be stored in a long-term memory, or may be further processed by the image processor 128 and transmitted to the operator workstation 110 for presentation on the display 118.

In various embodiments, components of the computer system 120 and the MRI system controller 130 may be implemented on the same computer system or on a plurality of computer systems. It should be understood that the MRI system 100 shown in FIG. 1 is intended for illustration. Suitable MRI systems may include more, fewer, and/or different components.

The MRI system controller 130 and the image processor 128 may separately or collectively include a computer processor and a storage medium. The storage medium records a predetermined data processing program to be executed by the computer processor. For example, the storage medium may store a program used to implement scanning processing (such as a scan flow and an imaging sequence), image reconstruction, medical imaging, etc. For example, the storage medium may store a computer program used to determine an orientation of a subject according to the embodiments of the present invention. The described storage medium may include, for example, a ROM, a floppy disk, a hard disk, an optical disk, a magneto-optical disk, a CD-ROM, or a non-volatile memory card.

The inventor has found that in the prior art, when a medical imaging system is used to scan a plurality of scanning regions, the operator manually sets the plurality of scanning regions, where in a process of setting the plurality of scanning regions, it is necessary to ensure that adjacent scanning regions are aligned, and that adjacent scanning regions have an overlap of a predetermined size in a specified direction so as to ensure that a range that needs to be scanned is completely covered, and this process of manually setting the scanning regions will increase the operator's workload and prolong operation time.

In view of at least one of the above problems, embodiments of the present application provide a scanning region setting method and apparatus for a medical imaging system, and a medical imaging system.

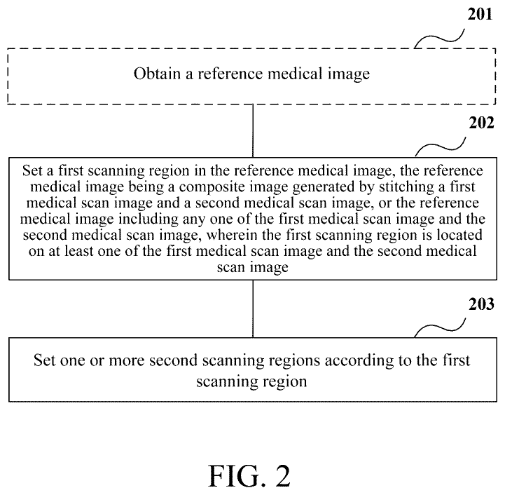

FIG. 2 is a schematic diagram of a scanning region setting method in an embodiment of the present application. As shown in FIG. 2, the scanning region setting method includes steps 202 and 203.
Step 202: Setting a first scanning region in a reference medical image, the reference medical image being a composite image generated by stitching a first medical scan image and a second medical scan image, or the reference medical image including any one of the first medical scan image and the second medical scan image, where the first scanning region is located on at least one of the first medical scan image and the second medical scan image; and
Step 203: Setting one or more second scanning regions according to the first scanning region.

In the method for setting a scanning region in an embodiment of the present application, one or more (that is, one or a plurality of) second scanning regions are automatically set according to a first scanning region, such that the workload in a process of setting a scanning region can be reduced, and the time required to set the scanning region can be shortened, thereby improving scanning efficiency.

As shown in FIG. 2, in some embodiments, the scanning region setting method may further include step 201 of obtaining a reference medical image.

Through operation 201, a reference medical image is obtained, and the reference medical image is used in operation 202. In addition, operation 201 may not be included in the scanning region setting method of the present application.

In the present application, the reference medical image is a composite image generated by stitching the first medical scan image and the second medical scan image, or the reference medical image includes any one of the first medical scan image and the second medical scan image.

The first medical scan image and the second medical scan image are, for example, 3-plane localizer images obtained by a medical imaging system (for example, a magnetic resonance system) scanning (for example, pre-scanning) some sites of a subject under examination (for example, the subject under examination 170 shown in FIG. 1), where the three planes include, for example, a sagittal plane, a coronal plane, and a horizontal plane.

For example, the first medical scan image is a 3-plane localizer image obtained by scanning the upper portion of the subject under examination (for example, a region containing the head, neck, and chest of the subject under examination), and the second medical scan image is a 3-plane localizer image obtained by scanning the lower portion of the subject under examination (for example, a region containing the chest and abdomen of the subject under examination). For another example, the first medical scan image or the second medical scan image is a 3-plane localizer image obtained by scanning a site of interest of the subject under examination (for example, a region containing the neck and chest of the subject under examination, corresponding to the middle of the torso of the subject under examination, or the like).

In some examples of operation 201, the first medical scan image and the second medical scan image are stitched to generate a composite image, and the composite image is used as a reference medical image, thereby obtaining the reference medical image. In some examples, which sites of the subject under examination that the first medical scan image and the second medical scan image respectively correspond to can be identified by using a predetermined algorithm (for example, an algorithm based on a deep learning model or the like), thereby setting relative positions of the first medical scan image and the second medical scan image, and then stitching the first medical scan image and the second medical scan image into one image, i.e., a composite image, according to the set relative positions. For a specific operation of stitching the first medical scan image and the second medical scan image, reference may be made to the related art.

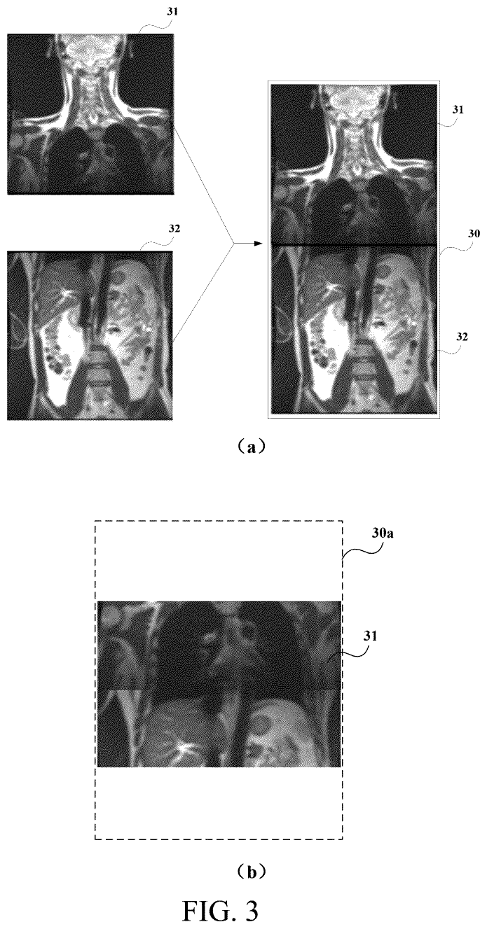

FIG. 3 is a schematic diagram of a reference medical image. As shown in (a) of FIG. 3, a first medical scan image 31 and a second medical scan image 32 respectively correspond to the upper portion and the lower portion of the subject under examination. The first medical scan image 31 is set on the upper side of the second medical scan image 32, and the first medical scan image 31 and the second medical scan image 32 are stitched to form a composite image 30, which is used as a reference medical image.

In some other examples of operation 201, the reference medical image may include the first medical scan image or the second medical scan image, that is, in these examples, only one scan needs to be performed on the subject under examination to obtain one of the first medical scan image and the second medical scan image, and thus the time of scanning can be shortened. As shown in (b) of FIG. 3, a reference medical image 30a may include the first medical scan image 31, for example, the area of the reference medical image 30a is greater than the area of the first medical scan image 31, that is, the reference medical image 30a may have two regions. One region of the two regions displays the first medical scan image 31, and the other region is a blank region (for example, the blank region is black, white, or has other colors or grayscales). Furthermore, the reference medical image 30a may alternatively include the second medical scan image 32. In operation 202, a first scanning region is set in the reference medical image. In some embodiments, the composite image 30 is used as a reference medical image (for example, as shown in (a) of FIG. 3), or the reference medical image includes the first medical scan image 31 or the second medical scan image 32 (for example, as shown in (b) of FIG. 3). The reference medical image can be displayed on a user interface (UI), and an operator can set the first scanning region on the user interface. For example, the operator can manually set the first scanning region on the composite image by clicking on a screen, dragging a mouse, or the like. The first scanning region may be located on at least one of the first medical scan image and the second medical scan image.

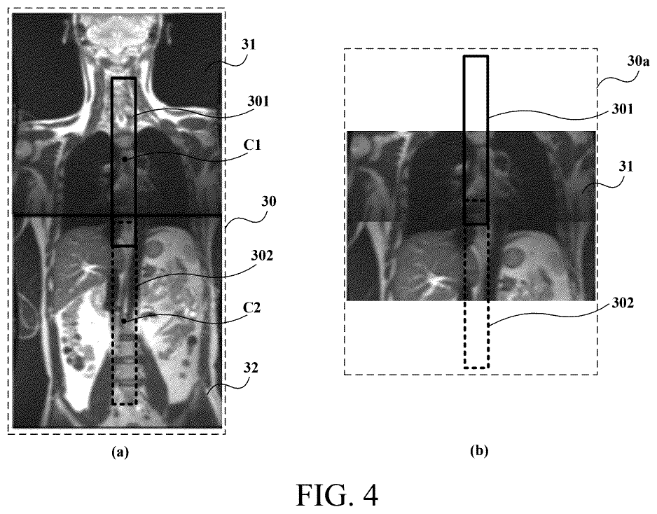

FIG. 4 is a schematic diagram of a first scanning region. In the example shown in (a) of FIG. 4, the first scanning region 301 set in the composite image 30 is mainly located on the first medical scan image 31, and a portion of the first scanning region 301 is located on the second medical scan image 32. A scan field of view corresponding to the first scanning region 301 is less than or equal to a scan field of view of the medical imaging system.

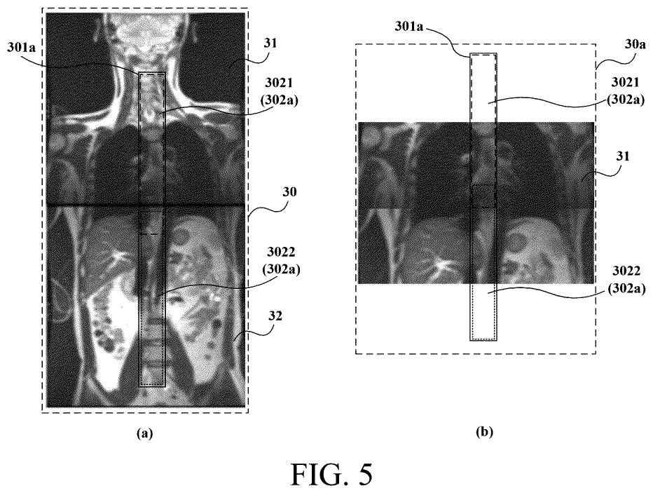

FIG. 5 is another schematic diagram of a first scanning region. In the example shown in (a) of FIG. 5, a first scanning region 301a set in the composite image 30 is located on the first medical scan image 31 and the second medical scan image 32. In addition, a scan field of view corresponding to the first scanning region 301a is greater than a scan field of view of the medical imaging system.

In addition, the example of the first scanning region is not limited to (a) of FIG. 4 or (a) of FIG. 5. For example, in some other examples, the first scanning region 301 may be located only on the first medical scan image 31, or the first scanning region 301 may be located only on the second medical scan image 32.

In the example shown in (b) of FIG. 4, a portion of the first scanning region 301 set in the reference medical image 30a is located on the first medical scan image 31, and another portion of the first scanning region 301 may be located in a blank region of the reference medical image 30a. A scan field of view corresponding to the first scanning region 301 is less than or equal to a scan field of view of the medical imaging system.

In the example shown in (b) of FIG. 5, a portion of the first scanning region 301a set in the reference medical image 30a is located on the first medical scan image 31, and another portion of the first scanning region 301a is located in a blank region of the reference medical image 30a. A scan field of view corresponding to the first scanning region 301a is greater than a scan field of view of the medical imaging system.

In addition, the example of the first scanning region is not limited to (b) of FIG. 4 or (b) of FIG. 5. For example, in some other examples, the first medical scan image 31 in (b) of FIG. 4 or (b) of FIG. 5 may be replaced with the second medical scan image 32.

In the examples shown in (b) of FIG. 4 and (b) of FIG. 5, a reference medical image is obtained based on one medical scan image (for example, the first medical scan image 31 or the second medical scan image 32), and the operator can set the first scanning region 301 or 301a on the reference medical image 30a based on his/her own experience without stitching a plurality of medical scan images. Therefore, the speed of setting the scanning region can be increased, thereby improving efficiency of scanning.

In operation 203, one second scanning region or more than one second scanning region may be set according to the first scanning region.

In some examples of operation 203, the scan field of view corresponding to the first scanning region is less than or equal to the scan field of view of the medical imaging system. One second scanning region may be set according to the first scanning region, and a scan field of view corresponding to the second scanning region is less than or equal to the scan field of view of the medical imaging system. The first scanning region and the second scanning region partially overlap, and the center of the first scanning region and the center of the second scanning region do not overlap

For example, in the example shown in (a) of FIG. 4, the second scanning region 302 is set according to the first scanning region 301, and the number of second scanning regions 302 is one, where the one second scanning region 302 may be located on the second medical scan image 32, and a field of view corresponding to the second scanning region 302 is less than or equal to the scan field of view of the medical imaging system. In addition, in some other examples, if a major portion of the first scanning region 301 is located on the second medical scan image 32, the second scanning region 302 may be located on the first medical scan image 31. Therefore, the second scanning region 302 on another 3-plane localizer image (for example, the second medical scan image 32) can be automatically set by using the first scanning region 301 mainly located on one 3-plane localizer image (for example, the first medical scan image 31), thereby avoiding the inconvenience and increase in workload caused by manually setting the second scanning region 302.

For another example, in the example shown in (b) of FIG. 4, the second scanning region 302 is set according to the first scanning region 301, and the number of second scanning regions 302 is one.

Furthermore, the medical imaging system can perform scanning of a plurality of scanning regions, that is, multi-station scanning, on the subject under examination (for example, the subject under examination 170 shown in FIG. 1) according to the first scanning region 301 and the second scanning region 302. For example, a site of the subject under examination corresponding to the first scanning region 301 is scanned, a site of the subject under examination corresponding to the second scanning region 302 is scanned, and medical scan images obtained by scanning the two sites are merged to cover a range that needs to be scanned in the subject under examination. The range that needs to be scanned in the subject under examination is, for example, a range in which the entire spine of the subject under examination is located.

In some other examples of operation 203, a plurality of (for example, two or more) second scanning regions are set according to the first scanning region. For example, in the example shown in (a) or (b) of FIG. 5, second scanning regions 302a are set according to the first scanning region 301a, and the number of second scanning regions 302a may be more than one (that is, two or more), where the number of second scanning regions 302a shown in the example shown in (a) or (b) of FIG. 5 is two, i.e., the second scanning regions 3021 and 3022. A field of view corresponding to each of the second scanning regions 3021 and 3022 is less than or equal to the scan field of view of the medical imaging system. Therefore, the operator sets one first scanning region 301a corresponding to a large field of view on the composite image 30, and the present application can automatically divide the first scanning region 301a into a plurality of (that is, two or more) second scanning regions 302a (for example, the second scanning regions 3021 and 3022), each corresponding to a small field of view, thereby avoiding the inconvenience and increase in workload caused by manually setting the plurality of second scanning regions 302a. In addition, the number of second scanning regions 302a shown in the example shown in (a) or (b) of FIG. 5 is two, but the present application is not limited thereto, and the number of second scanning regions 302a may be three or more than three.

Furthermore, the medical imaging system can perform scanning of a plurality of scanning regions, that is, multi-station scanning, on the subject under examination (for example, the subject under examination 170 shown in FIG. 1) according to a plurality of second scanning regions 302a. For example, sites of the subject under examination respectively corresponding to the second detection regions 3021 and 3022 are scanned, and medical scan images obtained by scanning the two sites are merged to cover a range that needs to be scanned in the subject under examination. The range that needs to be scanned may be a scanning range corresponding to the first scanning region 301a, for example, a range in which the entire spine of the subject under examination is located.

Hereinafter, operation 203 is described in detail with reference to the examples shown in (a) of FIG. 4 and (a) of FIG. 5. The description is also applicable to the examples shown in (b) of FIG. 4 and (b) of FIG. 5.

In some embodiments of operation 203, as shown in (a) of FIG. 4, the scan field of view corresponding to the first scanning region 301 is less than or equal to the scan field of view of the medical imaging system.

In some examples, the center C1 (for example, the geometric center) of the first scanning region 301 is located on one of the first medical scan image 31 and the second medical scan image 32, and the center C2 (for example, the geometric center) of the second scanning region 302 set on the composite image 30 is located on the other of the first medical scan image 31 and the second medical scan image 32.

For example, as shown in (a) of FIG. 4, the center C1 (for example, the geometric center) of the first scanning region 301 is located on the first medical scan image 31, and the center C2 (for example, the geometric center) of the second scanning region 302 set on the composite image 30 is located on the second medical scan image 32. For another example, the center C1 of the first scanning region 301 may be located on the second medical scan image 32, and the center C2 of the second scanning region 302 may be located on the first medical scan image 31.

In the following description, the case shown in (a) of FIG. 4 is described as an example.

As shown in (a) of FIG. 4, the first scanning region 301 and the second scanning region 302 partially overlap.

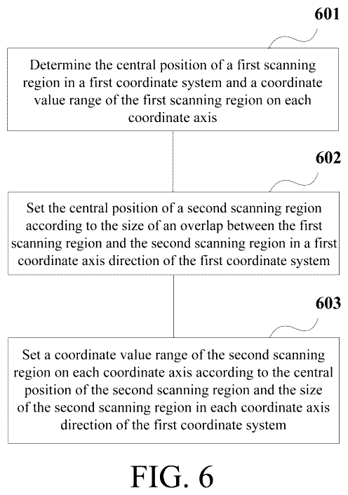

FIG. 6 is a schematic diagram of a method for setting one second scanning region according to a first scanning region, which, as an embodiment of operation 203, is used to generate the second scanning region 302 according to the first scanning region 301 shown in (a) of FIG. 4.

As shown in FIG. 6, the method for setting one second scanning region according to a first scanning region includes steps 601, 602 and 603.
601: Determining the central position of the first scanning region in a first coordinate system and a coordinate value range of the first scanning region on each coordinate axis;
602: Setting the central position of the second scanning region according to the size of an overlap between the first scanning region and the second scanning region in a first coordinate axis direction of the first coordinate system; and
603: Setting a coordinate value range of the second scanning region in the direction of each coordinate axis according to the central position of the second scanning region and the size of the second scanning region in each coordinate axis direction of the first coordinate system.

In operation 601, according to the first scanning region 301 set in the reference medical image (for example, the composite image 30), information such as the central position of the first scanning region 301 and the coordinate value range of the first scanning region 301 on each coordinate axis of the first coordinate system is determined. For example, the composite image 30 is formed by stitching the first medical scan image 31 and the second medical scan image 32, and both the first medical scan image 31 and the second medical scan image 32 are, for example, 3-plane localizer images, where the three planes include, for example, a sagittal plane, a coronal plane, and a horizontal plane (for example, the horizontal plane is also referred to as an axial plane). The 3-plane localizer images can be used to determine position information and size information of the subject under examination in the first coordinate system, and the first coordinate system is, for example, an anatomical coordinate system.

In some examples of operation 601, the position of the center C1 of the first scanning region 301 in the first coordinate system and the coordinate value range of the first scanning region 301 on each coordinate axis of the first coordinate system can be determined according to the information of the 3-plane localizer images.

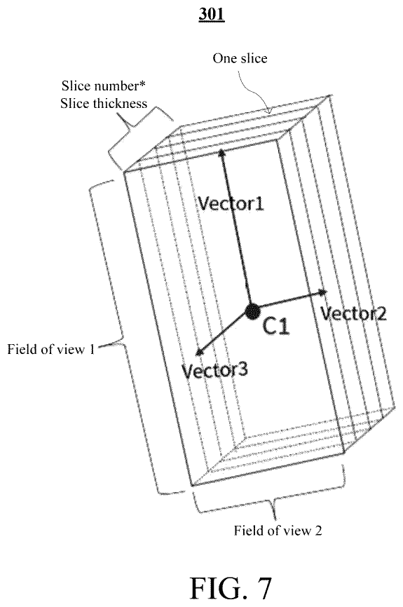

Hereinafter, operation 601 is described with reference to FIG. 7.

FIG. 7 is a schematic diagram of a first scanning region 301 in a first coordinate system. As shown in FIG. 7, the first scanning region 301 may be a three-dimensional (3D) region. For example, based on a plane region set by the operator on the user interface on which the composite image 30 is displayed, a three-dimensional region corresponding to the plane region is generated as the first scanning region 301.

It should be noted that, in the present application, the first scanning region 301 is represented as a rectangular parallelepiped region, which is only an example, and the present application is not limited thereto. For example, the first scanning region 301 may alternatively be set to be in other shapes other than a rectangular parallelepiped, such as a sphere, an ellipsoid, or a polyhedron.

The center C1 of the first scanning region 301 is, for example, the geometric center of the first scanning region 301. The position of the center C1 (that is, the central position) and the coordinate value range of the first scanning region 301 on each coordinate axis can be determined by performing image analysis on the first scanning region 301.

As shown in FIG. 7, in a first coordinate system (for example, an anatomical coordinate system):

The direction pointing from the center C1 of the first scanning region 301 toward the head of the subject under examination is referred to as a first coordinate axis direction, and the first coordinate axis direction is perpendicular to the horizontal plane of the three planes. In the first coordinate axis direction, a vector connecting the center C1 and the upper end (that is, an end close to the head of the subject under examination) of the first scanning region 301 is a first vector Vector1, that is, the first vector Vector1 is parallel to the first coordinate axis direction, and the length |Vector1| of the first vector Vector1 can be obtained based on image analysis of the first scanning region 301. Therefore, a coordinate value range of the first scanning region on the first coordinate axis is, for example, [−|Vector1|,|Vector1|], that is, the size of the first scanning region 301 in the first coordinate axis direction is 2*|Vector 1|.

The direction pointing from the center C1 of the first scanning region 301 toward the right side of the subject under examination is referred to as a second coordinate axis direction, and the second coordinate axis direction is perpendicular to the sagittal plane of the three planes. In the second coordinate axis direction, a vector connecting the center C1 and the right end (that is, an end close to the right side of the subject under examination) of the first scanning region 301 is a second vector Vector2, that is, the second vector Vector2 is parallel to the second coordinate axis direction, and the length |Vector2| of the second vector Vector2 can be obtained based on image analysis of the first scanning region 301. Therefore, a coordinate value range of the first scanning region on the second coordinate axis is, for example, [−|Vector2|,|Vector2|].

The direction pointing from the center C1 of the first scanning region 301 toward the front side of the subject under examination is referred to as a third coordinate axis direction, and the third coordinate axis direction is perpendicular to the coronal plane of the three planes. In the third coordinate axis direction, a vector connecting the center C1 and the front end (that is, an end close to the front side of the subject under examination) of the first scanning region 301 is a third vector Vector3, that is, the third vector Vector3 is parallel to the third coordinate axis direction, and the length |Vector3| of the third vector Vector3 can be obtained based on image analysis of the first scanning region 301. Therefore, a coordinate value range of the first scanning region on the third coordinate axis is, for example, [−|Vector3|,|Vector3|].

The first vector Vector1, the second vector Vector2, and the third vector Vector3 are given corresponding coefficients and are subjected to vector composing, and thus any point in the first scanning region 301 can be represented. In the present application, the size of the first scanning region 301 in the first coordinate axis direction can be determined according to a scan field of view of the medical imaging system in the first coordinate axis direction, that is, a scan field of view (that is, the field of view 1 in FIG. 7) corresponding to the size of the first scanning region 301 in the first coordinate axis direction is less than or equal to the scan field of view of the medical imaging system in the first coordinate axis direction. The scan field of view of the medical imaging system in the first coordinate axis direction is, for example, 50 cm or less than 50 cm.

The size of the first scanning region 301 in the second coordinate axis direction can be determined according to a scan field of view of the medical imaging system in the second coordinate axis direction, that is, a scan field of view (that is, the field of view 2 in FIG. 7) corresponding to the size of the first scanning region 301 in the second coordinate axis direction is less than or equal to the scan field of view of the medical imaging system in the second coordinate axis direction.

The size of the first scanning region 301 in the third coordinate axis direction can be determined according to the slice number of the medical imaging system during imaging in the third coordinate axis direction and the slice thickness of each slice in the third coordinate axis direction, that is, the size of the first scanning region 301 in the third coordinate axis direction is equal to the product of the slice thickness and the slice number of the medical imaging system during imaging in the third coordinate axis direction.

When the medical imaging system is used to perform scanning according to the first scanning region 301, a frequency encoding direction of the medical imaging system may be parallel to the first coordinate axis direction, a phase encoding direction of the medical imaging system may be parallel to the second coordinate axis direction, and a layer selection direction of the medical imaging system may be parallel to the third coordinate axis direction. For descriptions of the frequency encoding direction, the phase encoding direction, and the layer selection direction, reference may be made to the foregoing related descriptions of FIG. 1.

In operation 602, the position of the center C2 (that is, the central position) of the second scanning region 302 is set according to the size of an overlap D between the first scanning region 301 and the second scanning region 302 in the first coordinate axis direction of the first coordinate system.

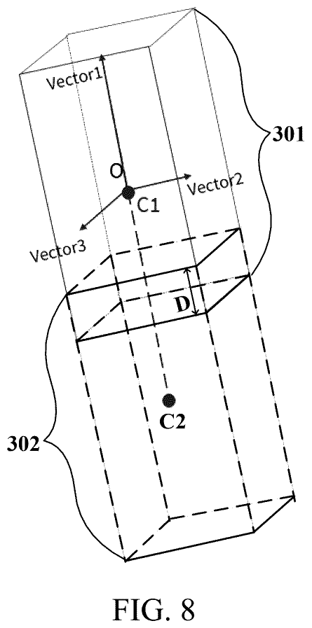

FIG. 8 is a schematic diagram of the center C1 of a first scanning region 301 and the center C2 of a second scanning region 302.

As shown in FIG. 8, in some examples, the center C2 of the second scanning region 302 is located below the center C1 of the first scanning region 301, and in the first coordinate axis direction, the distance d between the center C1 and the center C2 is equal to 2*|Vector1|−D. Therefore, the position of the center C2 is obtained by moving the center C1 downward by the distance d in the first coordinate axis direction. For example, the size of the overlap D may be 0.2 times the size of the first scanning region 301 in the first coordinate axis direction, that is, D=0.2*2*|Vector1|. Therefore, the distance d between the center C1 and the center C2 is equal to 2*0.8*|Vector1|.

In operation 603, a coordinate value range of the second scanning region 302 on each coordinate axis is set according to the position of the center C2 of the second scanning region 302 (for example, obtained through operation 602) and the size of the second scanning region 302 in each coordinate axis direction of the first coordinate system.

In some examples, the size of the first scanning region 301 in each coordinate axis direction of the first coordinate system is multiplied by a corresponding coefficient to obtain the size of the second scanning region 302 in each coordinate axis direction of the first coordinate system. For example, the coefficient is equal to 1, that is, the size of the second scanning region 302 in each coordinate axis direction of the first coordinate system is equal to the size of the first scanning region 301 in a corresponding coordinate axis direction of the first coordinate system, that is, the size of the second scanning region 302 in the first coordinate axis direction is 2*|Vector1|, the size of the second scanning region 302 in the second coordinate axis direction is 2*|Vector2|, and the size of the second scanning region 302 in the third coordinate axis direction is 2*|Vector3|.

Therefore, based on the position of the center C2 of the second scanning region 302 and the size of the second scanning region 302 in each coordinate axis direction of the first coordinate system, and in view of the shape of the second scanning region 302 (for example, the second scanning region 302 and the first scanning region 301 have the same shape, both of which are rectangular parallelepipeds), a value range of the second scanning region 302 on each coordinate axis of the first coordinate system can be determined. For example, a value range of the second scanning region 302 on the first coordinate axis is [−|Vector1|,|Vector1|], a value range of the second scanning region 302 on the second coordinate axis is [−|Vector2|,|Vector2|], and a value range of the second scanning region 302 on the third coordinate axis is [−|Vector3|,|Vector3|]. In addition, the slice thickness and the slice number corresponding to the second scanning region 302 may be the same as the slice thickness and the slice number corresponding to the first scanning region 301, respectively.

Through operations 601, 602, and 603, the second scanning region 302 is set, and the center C2 of the second scanning region 302 may be located on the second medical scan image 32. The second scanning region 302 can be displayed on the composite image 30, thereby facilitating confirmation by the operator.

In addition, if the operator adjusts the position or size of the second scanning region 302, the original first scanning region 301 will also be automatically adjusted along with the adjusted second scanning region 302. For a specific method in which the original first scanning region 301 is automatically adjusted along with the adjusted second scanning region 302, reference may be made to operations 601, 602, and 603 described above, that is, the adjusted second scanning region 302 can be considered as a new first scanning region in operations 601, 602, and 603, and a second scanning region set based on the new first scanning region is used to replace the original first scanning region 301.

In some other embodiments of operation 203, as shown in (a) of FIG. 5, the scan field of view corresponding to the first scanning region 301a is greater than the scan field of view of the medical imaging system. The number of second scanning regions 302a generated according to the first scanning region 301a is two or more, and two adjacent second scanning regions 302a partially overlap.

In the following description, (a) of FIG. 5 is used as an example for description, that is, the number of second scanning regions 302a is two, and the two second scanning regions 302a partially overlap.

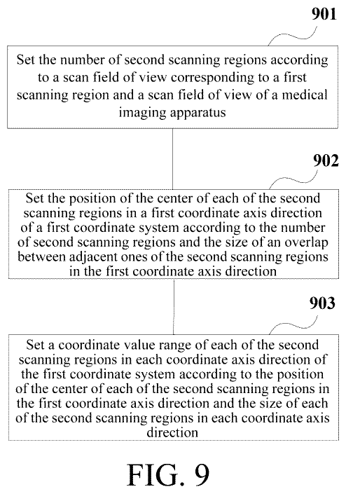

FIG. 9 is a schematic diagram of a method for setting two or more second scanning regions according to a first scanning region, which, as another embodiment of operation 203, is used to generate two or more (for example, two) second scanning regions 302a, i.e., second scanning regions 3021 and 3022, according to the first scanning region 301a shown in FIG. 5.

As shown in FIG. 9, the method for setting two or more second scanning regions according to a first scanning region includes steps 901, 902 and 903.
901: Setting the number of second scanning regions according to the scan field of view corresponding to the first scanning region and the scan field of view of the medical imaging system;
902: Setting the position of the center of each of the second scanning regions in a first coordinate axis direction of a first coordinate system according to the number of second scanning regions and the size of an overlap between adjacent ones of the second scanning regions in the first coordinate axis direction; and
903: Setting a coordinate value range of each of the second scanning regions in each coordinate axis direction of the first coordinate system according to the position of the center of each of the second scanning regions in the first coordinate axis direction and the size of each of the second scanning regions in each coordinate axis direction.

In the method shown in FIG. 9, the first coordinate system is, for example, an anatomical coordinate system. In the first coordinate system, the first coordinate axis direction is perpendicular to the horizontal plane in the three planes, the second coordinate axis direction is perpendicular to the sagittal plane in the three planes, and the third coordinate axis direction is perpendicular to the coronal plane in the three planes. In addition, for descriptions of the first coordinate system, the first coordinate axis direction, the second coordinate axis direction, and the third coordinate axis direction, reference may be made to the foregoing related descriptions of the method shown in FIG. 6.

In the present application, the first scanning region 301a may be a rectangular parallelepiped region, but the present application is not limited thereto. For example, the first scanning region 301a may alternatively be set to be in other shapes other than a rectangular parallelepiped, such as a sphere, an ellipsoid, or a polyhedron.

In the present application, a scan field of view corresponding to the size of the first scanning region 301a in the first coordinate axis direction is greater than the scan field of view of the medical imaging system in the first coordinate axis direction. The scan field of view of the medical imaging system in the first coordinate axis direction is, for example, 50 cm. Therefore, in operation 901, the number of second scanning regions 302a can be set according to the scan field of view (for example, F1) corresponding to the size of the first scanning region 301a in the first coordinate axis direction and the scan field of view (for example, F0) of the medical imaging system in the first coordinate axis direction.

For example, F1 is divided by F0, and if the decimal part of the quotient is less than a predetermined value (for example, 0.5), the quotient is rounded up, and the obtained result is the number of second scanning regions 302a. For another example, F1 is divided by F0, and if the decimal part of the quotient is greater than a predetermined value (for example, 0.5), the quotient is rounded up and then 1 is added thereto, and the obtained result is used as the number of second scanning regions 302a. In this way, it can be ensured that, when adjacent second scanning regions 302a overlap, a plurality of second scanning regions 302a can still cover the first scanning region 301a in the first coordinate axis direction.

In operation 902, the position of the center (for example, the geometric center) of each second scanning region in the first coordinate axis direction can be set according to the number of second scanning regions 302a (for example, obtained through operation 901) and the size of an overlap between adjacent ones of the second scanning regions 302a in the first coordinate axis direction.

In some examples, in the first coordinate axis direction, the center of the uppermost second scanning region among the plurality of second scanning regions is set with an upper end of the first scanning region 301a as the starting point. For example, the uppermost second scanning region is the second scanning region 3021 in (a) of FIG. 5. The size of the uppermost second scanning region in the first coordinate axis direction is, for example, a first predetermined size (for example, a scan field of view corresponding to the first predetermined size is less than or equal to F0), where the first predetermined size may be a size preset based on F0.

After the position of the center of the uppermost second scanning region is set, the central position of a lower second scanning region 302a (for example, the second scanning region 3022) can be set. For example, the center of the lower second scanning region 3022 is located below the center of the second scanning region 3021, and the size of an overlap between the lower second scanning region 3022 and the second scanning region 3021 in the first coordinate axis direction is D1. Thus, in the first coordinate axis direction, the distance d1 between the center of the second scanning region 3021 and the center of the second scanning region 3022 is equal to the difference between the first predetermined size and D1. Therefore, the central position of the second scanning region 3022 is obtained by moving the center of the second scanning region 3021 downward by the distance d1 in the first coordinate axis direction.

By analogy, if there is another second scanning region 302a below the second scanning region 3022, the central position of the other second scanning region 302a is set according to the central position of the second scanning region 3022 and the size of an overlap between the second scanning region 3022 and the other second scanning region 302a.

In operation 903, a coordinate value range of each second scanning region on each coordinate axis is set according to the position of the center of each second scanning region 302a in the first coordinate axis direction and the size of each second scanning region 302a in each coordinate axis direction of the first coordinate system.

In some examples, the size of the second scanning region 302a in the first coordinate axis direction may be the first predetermined size described above. Sizes of the first scanning region 301a in the second coordinate axis direction and the third coordinate axis direction of the first coordinate system are multiplied by corresponding coefficients to obtain sizes of the second scanning region 302a in the second coordinate axis direction and the third coordinate axis direction. For example, the coefficient is equal to 1, that is, the sizes of the second scanning region 302a in the second coordinate axis direction and the third coordinate axis direction are respectively equal to the sizes of the first scanning region 301a in the second coordinate axis direction and the third coordinate axis direction.

Therefore, based on the position of the center of each second scanning region 302a and the size of the second scanning region 302a in each coordinate axis direction of the first coordinate system, and in view of the shape of the second scanning region 302a (for example, the second scanning region 302a and the first scanning region 301a are both rectangular parallelepipeds), a value range of each second scanning region 302a on each coordinate axis of the first coordinate system can be determined.

Through operations 901, 902, and 903, two or more second scanning regions 302a are set. The two or more second scanning regions 302a can be displayed on the composite image 30, thereby facilitating confirmation by the operator.

In addition, if the operator adjusts the position or size of any second scanning region 302a, the other second scanning regions 302a will also be automatically adjusted along with the adjusted second scanning region 302a. For example, after the position or size of one second scanning region 302a is adjusted, a second scanning region 302a that overlaps with the second scanning region 302a will also be adjusted accordingly (for a specific method, reference may be made to the method shown in FIG. 6), and then the adjustment will be transmitted to more second scanning regions 302a.

The embodiments of the present application further provide an apparatus for setting a scanning region, and the content of which that is the same as that in the foregoing embodiments is not described again here.

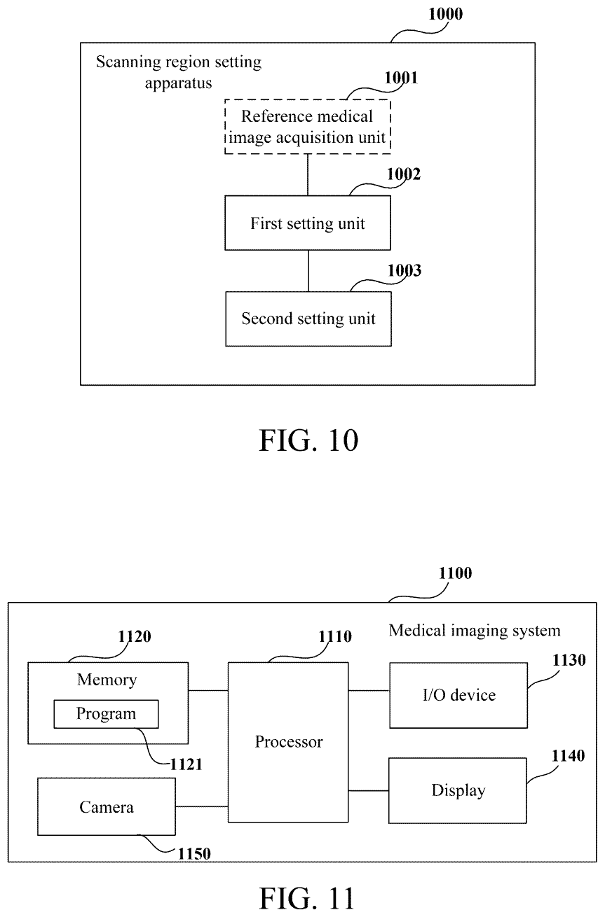

FIG. 10 is a schematic diagram of an apparatus for setting a scanning region according to an embodiment of the present application. As shown in FIG. 10, a scanning region setting apparatus 1000 includes:

A first setting unit 1002 configured to set a first scanning region in a reference medical image, where the reference medical image is a composite image generated by stitching a first medical scan image and a second medical scan image, or the reference medical image includes any one of the first medical scan image and the second medical scan image, where the first scanning region is located on at least one of the first medical scan image and the second medical scan image; and

A second setting unit 1003 configured to set one or more second scanning regions according to the first scanning region.

In addition, as shown in FIG. 10, the scanning region setting apparatus 1000 may further include a reference medical image acquisition unit 1001. The reference medical image acquisition unit 1001 is configured to obtain a reference medical image. For example, the reference medical image acquisition unit 1001 stitches the first medical scan image and the second medical scan image to form a composite image, and the composite image is used as the reference medical image. For another example, the reference medical image acquisition unit 1001 forms a reference medical image based on any one of the first medical scan image and the second medical scan image. The reference medical image obtained by the reference medical image acquisition unit 1001 can be sent to the first setting unit 1002 and the second setting unit 1003 for setting the first scanning region and the second scanning region.

In addition, in some embodiments, the reference medical image acquisition unit 1001 may not be included in the scanning region setting apparatus 1000.

For detailed descriptions of various units of the scanning region setting apparatus 1000, reference may be made to related descriptions of various steps of the scanning region setting method in the foregoing embodiments.

It is worth noting that only the components or modules related to the present application have been described above, but the present application is not limited thereto. The apparatus may further include other components or modules, and reference may be made to the related art for details of these components or modules.

For the sake of simplicity, FIG. 10 only exemplarily illustrates the connection relationships or signal directions between various components or modules, but it should be clear to those skilled in the art that various related technologies such as bus connection can be used. The various components or modules described above can be implemented by means of hardware such as a processor or a memory, etc. The embodiments of the present application are not limited thereto.

The above embodiments merely provide illustrative descriptions of the embodiments of the present application. However, the present application is not limited thereto, and suitable variations may be made on the basis of the above embodiments. For example, each of the above embodiments may be used independently, or one or more of the above embodiments may be combined.

Embodiments of the present application further provide a medical imaging system. The scanning region setting apparatus 1000 is included, the contents of which are incorporated here. The medical imaging device may, for example, have a computer, a server, a workstation, a laptop computer, a smart phone, or the like. However, the embodiments of the present application are not limited thereto.

FIG. 11 is a schematic diagram of a medical imaging system according to an embodiment of the present application. As shown in FIG. 11, the medical imaging system 1100 may include: one or more processors (for example, central processing units (CPUs)) 1110 and one or more memories 1120. The memory 1120 is coupled to the processor 1110. The memory 1120 may store various types of data. In addition, the memory further stores a program 1121 for information processing, and executes the program 1121 under the control of the processor 1110.

In some embodiments, the functions of the scanning region setting apparatus 1000 are integrated into the processor 1110 for implementation. The processor 1110 is configured to implement the scanning region setting method as described in the foregoing embodiments of the present application.

In some embodiments, the scanning region setting apparatus 1000 and the processor 1110 are configured separately. For example, the scanning region setting apparatus 1000 can be configured to be a chip connected to the processor 1110 and the functions of the scanning region setting apparatus 1000 can be achieved by means of the control of the processor 1110.

For example, the processor 1110 is configured to perform the following controls: setting a first scanning region in a reference medical image, the reference medical image being a composite image generated by stitching a first medical scan image and a second medical scan image, or the reference medical image comprising any one of the first medical scan image and the second medical scan image, where the first scanning region is located on at least one of the first medical scan image and the second medical scan image; and setting one or more second scanning regions according to the first scanning region.

In a specific example, the medical imaging system 1100 of FIG. 11 may be the magnetic resonance imaging (MRI) system 100 shown in FIG. 1. The reference medical image used in the scanning region setting method may be obtained based on a medical scan image (for example, at least one of the first medical scan image and the second medical scan image) acquired through a pre-scanning procedure executed by the magnetic resonance imaging system 100.

The memory 1120 of FIG. 11 may correspond to at least one of the memory 137 and the memory 126 of FIG. 1. For example, the memory 1120 may be independent of at least one of the memory 137 and the memory 126, or the memory 1120 may be in communication with at least one of the memory 137 and the memory 126, or the memory 1120 may include at least one of the memory 137 and the memory 126, etc. The processor 1110 of FIG. 11 may correspond to at least one of the CPU 131, the CPU 124, and the image processor 128 of FIG. 1. For example, the processor 1110 may be independent of at least one of the CPU 131, the CPU 124, and the image processor 128, or the processor 1110 may be in communication with at least one of the CPU 131, the CPU 124, and the image processor 128, or the processor 1110 may include at least one of the CPU 131, the CPU 124, and the image processor 128, etc.

In addition, as shown in FIG. 11, the medical imaging system 1100 may further include: an input/output (I/O) device 1130, a display 1140, or the like. The functions of the foregoing components are similar to those in the prior art. Details are not described herein again.

In addition, as shown in FIG. 11, the medical imaging system 1100 may further include a camera 1150.

It is worth noting that the medical imaging system 1100 does not necessarily include all of the components shown in FIG. 11. In addition, the medical imaging system 1100 may further include components not shown in FIG. 11, for which reference may be made to the related art.

In the present application, when scanning the subject under examination 170, the medical imaging system 1100 (for example, the magnetic resonance imaging system 100) can use the scanning region setting method (as shown in FIG. 2) of the present application to set a scanning region, thereby improving scanning efficiency.

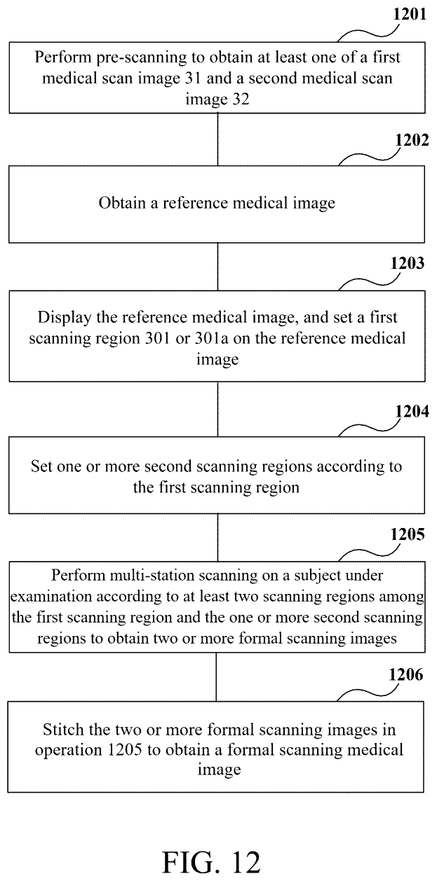

FIG. 12 is a schematic diagram of a scanning procedure performed by a magnetic resonance imaging system 100. As shown in FIG. 12, the scanning procedure includes the following steps:
1201: The magnetic resonance imaging system 100 pre-scans the subject under examination to obtain at least one of the first medical scan image 31 and the second medical scan image 32. For example, the magnetic resonance imaging system 100 respectively performs a pre-scan (that is, performs two pre-scans) on two sites of the subject under examination to obtain the first medical scan image 31 and the second medical scan image 32. For another example, the magnetic resonance imaging system 100 performs a pre-scan (that is, performs one pre-scan) on one site of the subject under examination to obtain the first medical scan image 31 or the second medical scan image 32.
1202: The magnetic resonance imaging system 100 obtains a reference medical image based on the at least one of the first medical scan image 31 and the second medical scan image 32. For example, the magnetic resonance imaging system 100 stitches the first medical scan image 31 and the second medical scan image 32 to obtain a composite image 30 (as shown in (a) of FIG. 3), and uses the composite image 30 as a reference medical image. For another example, the magnetic resonance imaging system 100 generates a reference medical image 30a (as shown in (b) of FIG. 3) based on one of the first medical scan image 31 and the second medical scan image 32.
1203: The display 118 (as shown in FIG. 1) of the magnetic resonance imaging system 100 displays the reference medical image (for example, the magnetic image 30 or the reference medical image 30a), and sets a first scanning region 301 (as shown in (a) or (b) of FIG. 4) or 301a (as shown in (a) or (b) of FIG. 5) on the reference medical image based on the operation of the operator. For example, the operator marks a rectangular frame on the reference medical image by using the input device 114 or the control panel 116 as shown in FIG. 1, and the rectangular frame corresponds to the first scanning region 301 or 301a.
1204: The magnetic resonance imaging system 100 sets one or more second scanning regions according to the first scanning region. For example, as shown in (a) or (b) of FIG. 4, a scan field of view corresponding to the first scanning region 301 is less than or equal to a scan field of view of the medical imaging system 100, and one second scanning region 302 is set according to the first scanning region 301. For another example, as shown in (a) or (b) of FIG. 5, the scan field of view corresponding to the first scanning region 301a is greater than the scan field of view of the medical imaging system 100, and two or more second scanning regions 302a are set according to the first scanning region 301a.
1205: The magnetic resonance imaging system 100 performs scanning of a plurality of scanning regions (for example, the scanning may be referred to as formal scanning) on the subject under examination (for example, the subject under examination 170 shown in FIG. 1) according to at least two scanning regions among the first scanning region and the one or more second scanning regions, that is, multi-station scanning. For example, corresponding to the example shown in (a) or (b) of FIG. 4, the magnetic resonance imaging system 100 respectively performs scanning on a site of the subject under examination corresponding to the first scanning region 301 and a site of the subject under examination corresponding to the second scanning region 302 to obtain two or more formal scanning images. For another example, corresponding to the example shown in (a) or (b) of FIG. 5, the magnetic resonance imaging system 100 respectively performs scanning on a site of the subject under examination corresponding to the second scanning region 3021 and a site of the subject under examination corresponding to the second detection region 3022 to obtain two or more formal scanning images.
1206: The magnetic resonance imaging system 100 stitches the two or more formal scanning images obtained in operation 1205 to obtain a formal scanning medical image, and the formal scanning medical image can cover two or more sites of the subject under examination. Therefore, when a range that needs to be scanned in the subject under examination exceeds a field of view of the magnetic resonance imaging system 100, a medical image covering the range that needs to be scanned can also be obtained. For example, the range that needs to be scanned in the subject under examination is a range in which the entire spine of the subject under examination is located.

Embodiments of the present application further provide a computer-readable program that, when executed in a medical imaging system, causes a computer to perform, in the medical imaging system, the scanning region setting method described in the foregoing embodiments.

The embodiments of the present application further provide a storage medium storing a computer-readable program, where the computer-readable program causes a computer to perform, in a medical imaging system, the scanning region setting method described in the foregoing embodiments.

The above apparatus and method of the present application can be implemented by hardware, or can be implemented by hardware in combination with software. The present application relates to such a computer-readable program that when executed by a logic component, the program causes the logic component to implement the foregoing apparatus or a constituent component, or causes the logic component to implement various methods or steps as described above. The present application further relates to a storage medium for storing the above program, such as a hard disk, a disk, an optical disk, a DVD, a flash memory, etc.

The method/apparatus described in view of the embodiments of the present application may be directly embodied as hardware, a software module executed by a processor, or a combination of the two. For example, one or more of the functional block diagrams and/or one or more combinations of the functional block diagrams shown in the drawings may correspond to either respective software modules or respective hardware modules of a computer program flow. The foregoing software modules may respectively correspond to the steps shown in the figures. The foregoing hardware modules can be implemented, for example, by firming the software modules using a field-programmable gate array (FPGA).

The software modules may be located in a RAM, a flash memory, a ROM, an EPROM, an EEPROM, a register, a hard disk, a portable storage disk, a CD-ROM, or any other form of storage medium known in the art. The storage medium may be coupled to a processor, so that the processor can read information from the storage medium and can write information into the storage medium. Alternatively, the storage medium may be a constituent component of the processor. The processor and the storage medium may be located in an ASIC. The software module may be stored in a memory of a mobile terminal, and may also be stored in a memory card that can be inserted into a mobile terminal. For example, if a device (such as a mobile terminal) uses a large-capacity MEGA-SIM card or a large-capacity flash memory apparatus, the software modules can be stored in the MEGA-SIM card or the large-capacity flash memory apparatus.

One or more of the functional blocks and/or one or more combinations of the functional blocks shown in the accompanying drawings may be implemented as a general-purpose processor, a digital signal processor (DSP), an application-specific integrated circuit (ASIC), a field-programmable gate array (FPGA) or other programmable logic devices, discrete gate or transistor logic devices, a discrete hardware assembly, or any appropriate combination thereof for implementing the functions described in the present application. The one or more functional blocks and/or the one or more combinations of the functional blocks shown in the accompanying drawings may also be implemented as a combination of computing devices, such as a combination of a DSP and a microprocessor, multiple microprocessors, one or more microprocessors in communication combination with a DSP, or any other such configuration.

The present application is described above with reference to specific implementations. However, it should be clear to those skilled in the art that the foregoing description is merely illustrative and is not intended to limit the scope of protection of the present application. Various variations and modifications may be made by those skilled in the art according to the principle of the present application, and said variations and modifications also fall within the scope of the present application.

What is claimed is:

1. A scanning region setting method for a medical imaging system, characterized by comprising:
setting a first scanning region in a reference medical image, the reference medical image being a composite image generated by stitching a first medical scan image and a second medical scan image, or the reference medical image comprising any one of the first medical scan image and the second medical scan image, wherein the first scanning region is located on at least one of the first medical scan image and the second medical scan image; and
setting one or more second scanning regions according to the first scanning region.

2. The method according to claim 1, wherein
a scan field of view corresponding to the first scanning region is less than or equal to a scan field of view of the medical imaging system, and
one second scanning region is set according to the first scanning region, and a scan field of view corresponding to the second scanning region is less than or equal to the scan field of view of the medical imaging system;
wherein the first scanning region and the second scanning region partially overlap, and the center of the first scanning region and the center of the second scanning region do not overlap.

3. The method according to claim 2, wherein
the center of the first scanning region is located on one of the first medical scan image and the second medical scan image, and the center of the second scanning region set on the composite image is located on the other of the first medical scan image and the second medical scan image.

4. The method according to claim 2, wherein
one second scanning region being set according to the first scanning region comprises:
determining the central position of the first scanning region in a first coordinate system and a coordinate value range of the first scanning region on each coordinate axis;
setting the central position of the second scanning region according to the size of an overlap between the first scanning region and the second scanning region in a first coordinate axis direction of the first coordinate system; and
setting a coordinate value range of the second scanning region in each coordinate axis direction of the first coordinate system according to the central position of the second scanning region and the size of the second scanning region in each coordinate axis direction.

5. The method according to claim 3, further comprising:
when the size or the position of the second scanning region is adjusted, adjusting the size or the position of the first scanning region according to the adjusted size or position of the second scanning region.

6. The method according to claim 1, wherein
a scan field of view corresponding to the first scanning region is greater than a scan field of view of the medical imaging system,
the number of second scanning regions is two or more, and
two adjacent ones of the second scanning regions partially overlap.

7. The method according to claim 6, wherein
setting two or more of the second scanning regions according to the first scanning region comprises:
setting the number of second scanning regions according to the scan field of view corresponding to the first scanning region and the scan field of view of the medical imaging system;
setting the position of the center of each of the second scanning regions in a first coordinate axis direction of a first coordinate system according to the number of second scanning regions and the size of the overlap between adjacent ones of the second scanning regions in the first coordinate axis direction; and
setting a coordinate value range of each of the second scanning regions in each coordinate axis direction of the first coordinate system according to the position of the center of each of the second scanning regions in the first coordinate axis direction and the size of each of the second scanning regions in each coordinate axis direction.

8. A medical imaging system, comprising a memory and a processor, the memory storing a computer program, and the processor being configured to execute the computer program to implement the scanning region setting method according to claim 1.

9. The medical imaging system according to claim 8, wherein
the medical imaging system comprises a magnetic resonance imaging system.

10. The medical imaging system according to claim 9, wherein
the reference medical image used in the scanning region setting method is obtained based on a medical scan image acquired through a pre-scanning procedure executed by the magnetic resonance imaging system.

11. A scanning region setting apparatus for a medical imaging system, characterized by comprising:
a first setting unit configured to set a first scanning region in a reference medical image, the reference medical image being a composite image generated by stitching a first medical scan image and a second medical scan image, or the reference medical image comprising any one of the first medical scan image and the second medical scan image, wherein the first scanning region is located on at least one of the first medical scan image and the second medical scan image; and
a second setting unit configured to set one or more second scanning regions according to the first scanning region.

12. The apparatus according to claim 11, wherein
a scan field of view corresponding to the first scanning region is less than or equal to a scan field of view of the medical imaging system, one second scanning region is set according to the first scanning region, and a scan field of view corresponding to the second scanning region is less than or equal to the scan field of view of the medical imaging system, wherein the first scanning region and the second scanning region partially overlap, and the center of the first scanning region and the center of the second scanning region do not overlap.

13. The apparatus according to claim 11, wherein
a scan field of view corresponding to the first scanning region is greater than a scan field of view of the medical imaging system, the number of second scanning regions is two or more, and two adjacent ones of the second scanning regions partially overlap.
